(19) United States
(12) Patent Application Publication
(10) Pub. No.: US 2005/0235293 A1
(43) Pub. Date: Oct. 20, 2005

(54) Methods and systems for framework layout editing operations

(75) Inventors: Filipe Fortes, Seattle, WA (US); Greg Lett, Redmond, WA (US); Oleg V. Ovetchkine, Kirkland, WA (US); Sujal Parikh, Redmond, WA (US); Dmitry Titov, Redmond, WA (US); Grzegorz Zygmunt, Sammamish, WA (US)

Correspondence Address: MICROSOFT CORPORATION;C/O MERCHANT & GOULD, L.L.C., P.O. BOX 2903, MINNEAPOLIS, MN, 55402-0903, US

(73) Assignee: Microsoft Corporation, Redmond, WA (US)

(21) Appl. No.: 10/824,998

(22) Filed: Apr. 14, 2004

(51) Int. Cl. G06F 3/00

(52) U.S. Cl. 719/328; 719/329

(57) ABSTRACT

Methods, systems, and computer-readable media for enhanced layout editing of one or more child objects within a container displayed by a computer system are disclosed. Editing first involves detecting a layout edit operation for a child object displayed on a video display of a computer system. A request is then sent via an application program interface provided by an abstraction layer to initiate editing of the object layout by the abstraction layer. The abstraction layer receives the edit operation request and determines the layout limitations and type of parent object or container in which the child object is displayed based on properties related to the child object to be edited. The abstraction layer reads a set of properties related to the object and the container in which the object is displayed. The abstraction layer then edits the layout of the child object based the properties of child and the parent container by modifying one or more of the properties of the child object or the parent container in accordance with constraints either associated with the child object or its parent container, or both, and includes accommodation for modifications in accordance with one or more functional relationships defined between the parent and child.

### CROSS-REFERENCE TO RELATED APPLICATIONS

This application is related to copending United States Patent Application entitled “SYSTEMS AND METHODS FIR MANAGING PREPARATION OF GRAPHICAL ELEMENTS FOR PRESENTATION”, Ser. No. 10/691,349, filed Oct. 22, 2003; United States Patent Application entitled “SYSTEMS AND METHODS FOR PREPARING GRAPHICAL ELEMENTS FOR PRESENTATION”, Ser. No. 10/692,200, filed Oct. 23, 2003, and United States Patent Application entitled “SYSTEMS AND METHODS FOR PAGINATION AND COPAGINATION” Ser. No. 10/692,111 filed Oct. 23, 2003.

### TECHNICAL FIELD

The present invention relates generally to the field of graphical user interfaces and more particularly to a method and system for dynamically honoring children and parent specified size and arrangements in a display object on a graphical user interface.

### BACKGROUND OF THE INVENTION

A central feature of modern computer operating systems is the ability to present and manage graphical items on an output device, such as a video monitor or printer. When a graphical item is created within an application, the item is sized and placed appropriately for rendering on the output device. Similarly, when an existing graphical item is modified or removed within an application, the output device must reflect this change appropriately. Existing computer operating systems make use of device drivers to communicate with particular output devices, thus sparing an application developer from the messy details of rendering graphical output on specific output devices. Existing computer operating systems accomplish this by publishing Application Programming Interfaces (“APIs”) to prospective application developers.

Generally, an API is a set of high-level function calls made available to an application developer that are independent from the low-level instructions necessary for any particular device. The operating system, with the aid of device drivers, typically performs any needed translation of the high-level API calls to the low-level device-specific calls.

Nevertheless, although an application developer may not wish to concern himself with implementing how his application's graphical elements are physically displayed or rendered on any particular output devices, the developer may be interested in how those elements are logically laid out and managed. For example, an application developer may wish to develop a graphical user interface that displays its menus or arranges icons in a particular manner. Or a developer may wish to develop an application that arranges and displays multiple graphical elements in a single document in a particular fashion.

Existing software tools known in the art have given application developers some of these abilities. WINDOWS USER, for example, provided an API suited for controlling layout in a user interface scenario. MSHTML, on the other hand, provided an API suited for controlling layout in a document scenario. Trying to use either of these APIs in the other scenario, however, greatly increases the programming complexity while severely limiting performance. Furthermore, existing software tools are often too complex for developers who are not experienced with layout algorithms. Further still, existing software tools perform sub-optimally, such that updating a display layout requires significantly more time than necessary.

Accordingly, several new methods and systems to improve the ease with which developers can manage the layout of graphical elements in development environments have been developed. These methods and systems are disclosed in the United States patent applications referenced above and assigned to the assignee of the present invention. It is with respect to these considerations and others that the present invention has been made.

### SUMMARY OF THE INVENTION

The framework layout method and system in accordance with an embodiment of the present invention utilizes an abstraction layer application programming interface (API) that consistently handles and maintains specific sizes and/or ratios of sizes on children in all scenarios, including minimum and maximum widths, heights, margins of content of objects in a container and provides intelligent computation of actual size given conflicts in specified minimum and maximum sizes and can accommodate sizes specified in absolute, percentage, and typographic units in all scenarios.

For example, assume a user wants to ensure that a button will always be 400 pixels wide and 200 pixels high. The abstraction layer or API of the present invention ensures that this specified size is maintained regardless of context. Alternatively, if the user wants to ensure that the button will be proportionally sized in accordance with a predetermined percentage of parent content, the API of the invention will ensure that the proportion is maintained. Thus percentage sizing in size to content scenarios is accommodated. This is done conveniently by providing child helper functions in the API which read common properties, resolve conflicts, and use those values to drive child object layout. For example, the abstraction layer/API may resolve conflicts such as where minimum width of the child is greater than the maximum width of the parent, compute percentage values for relative and typographical units, and drive child layout to ensure that specified values are honored, i.e. maintained. Through the abstraction layer interface to each of these operations, an application program may affect the editing operation without code specific to that editing operation and without detailed knowledge of the object's parent container.

In accordance with other aspects, the present invention relates to a system for coordinated layout editing of objects displayed on a video display considering the constraints placed on the child object and the parent container. The system comprises a processor and a memory coupled with and readable by the processor. The memory contains instructions that, when executed by the processor, cause the processor to detect a layout edit operation for an object displayed on a video display of a computer system. A layout edit operation request is then sent to an abstraction layer via an interface provided by the abstraction layer to initiate editing of the object by the abstraction layer. The abstraction layer receives the edit operation request and determines the type of container in which the object is displayed based on properties related to the object to be edited. The abstraction layer then reads a set of properties related to the object to be edited and a set of properties related to the container in which the object is displayed. The abstraction layer may then edit the object based the properties of the container and object by modifying one or more of the properties of the container and object.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 illustrates abstraction of object layout modification operations according to an embodiment of the present invention.

FIG. 2 illustrates an example of a suitable computing system environment on which embodiments of the invention may be implemented.

FIG. 3 illustrates functional components of a system for abstraction of logical editing operations according to an embodiment of the present invention.

FIG. 4 is a flowchart of framework layout editing operations in an embodiment of the present invention.

FIG. 5 is a flowchart of a child measure helper routine in an embodiment of the present invention.

FIG. 6 is a flowchart of an arrange child helper routine in an embodiment of the present invention.

### DETAILED DESCRIPTION OF THE INVENTION

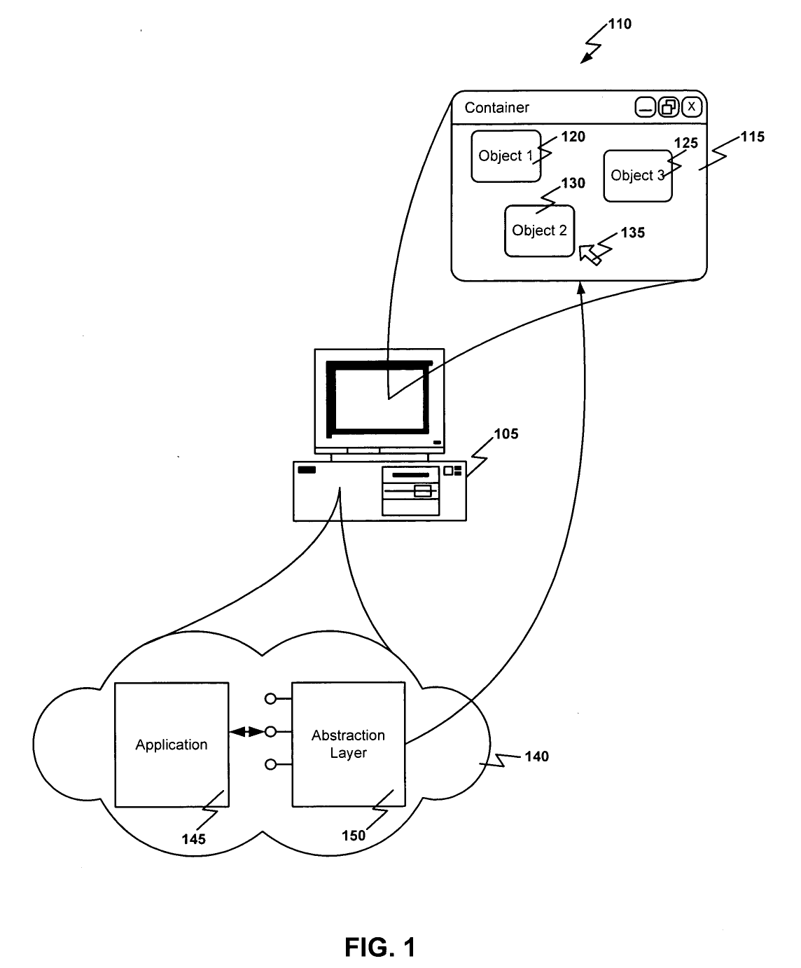

FIG. 1 illustrates a very high level abstraction of framework layout editing operations according to an embodiment of the present invention. In this example, a computer system 105 executes software 140 and provides a display 110 of information. The display 110 includes a parent container 115 that in turn includes a number of children objects 120, 125, and 130. The container 115 may be, as shown here, a window or another type of container such as a desktop, a document, a folder, or other object. The objects 120, 125, and 130 within the container may be any of a variety of different objects such as user interface elements, graphics, blocks of text, etc. that may be arranged in any of a variety of ways. For example, the objects 120-130 may be arranged by absolute position based on x, y coordinates within the container 115 as shown here, flowing from left to right or right to left along the top or bottom of the container 115, docketed to an edge of the container 115 such as the left side or right side of the container 115, some combination of these arrangements, or in another arrangement.

Also shown on the display 110 is a cursor 135 that may be moved by a user of computer system 105 using a mouse or other pointing device to select and/or manipulate the objects 120-130. For example, a user, by manipulating a mouse, may position the cursor over an object and select and move, i.e., drag and drop, an object to move that object. In another example, a user may resize or rotate an object by dragging and dropping an edge or corner of the object.

Software 140 executed on the computer system 105 may include one or more applications 145. The application 145, such as a word processor, spreadsheet, web browser, or other program, may generate the container 115 and/or the objects 120-130 contained therein. To arrange and edit the objects, the application uses the abstraction layer 150. That is, rather than directly arranging and editing the objects 120-130 which would require specific layout algorithms within the application, the application 145 calls, invokes, instantiates, or otherwise initiates execution of the abstraction layer 150. The abstraction layer 150 then, with knowledge of the container 115 and objects 120-130, positions or edits the layout of the objects 120-130 within the container 115 on the display 110.

The abstraction layer 150, as an application program interface (API), may obtain knowledge of the objects 120-130 and container 115 in a variety of ways. For example, the abstraction layer may read a type attribute for each object and the container. Alternatively, the abstraction layer may read a property setting for each child object and the parent container. In another example, the abstraction layer may read an object type and/or container type from a registry or other persistent memory.

When a user of the computer system 105 uses a mouse or other pointing device to select or manipulate the objects 120-130, a user may manipulate the cursor 135 to select and move, i.e. drag-and-drop, one of the objects 130. In such a case, the application 145 may call, invoke, instantiate, or otherwise initiate execution of a move method or operation of the abstraction layer 150, i.e., within its corresponding interface or API. In this way, the application 145 need not contain code for editing or arranging the objects 120-130 in the container 115. The application 145 simply detects the editing operation and passes the appropriate parameters to the abstraction layer 150.

The abstraction layer 150 may represent a class with specific knowledge, i.e., properties of the child object and its parent object or container. Having this knowledge allows the abstraction layer 150 to make specific changes to affect the editing action. The abstraction layer 150, by presenting a number of methods, allows editing operations such as move, resize, rotate, stretch, skew, etc. to be applied to a container or objects within that container without requiring the application 145 to know how objects are positioned or arranged within the container. That is, the abstraction layer 150 translates logical editing operations such as move or resize into changes to object-specific properties such as width, height, absolute position, etc. depending upon the object and container and other parameters. Additionally, the abstraction layer 150 handles editing of objects when the container controls the display of the object. For example, the parent container may, depending upon its type, control the positioning of the object. In such a case, the abstraction layer 150 may edit the properties of the container to affect the editing operation on the object.

The abstraction layer 150 may also allow more than one application 145 to easily modify the same object and/or container. For example, since specific knowledge of the object and container is available to the abstraction layer 150, applications do not need to obtain or maintain this information. In order to edit an object or container, the application simply accesses the logical editing operation via the appropriate interface of the abstraction layer 150. That is, if the abstraction layer 150 is implemented as a class, multiple applications may access the logical editing operations of that class by instantiating an object of that class and invoking the method for performing the desired operation using the appropriate interface.

The operations of the various embodiments of the present invention are implemented (1) as a sequence of computer implemented acts, operations, or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

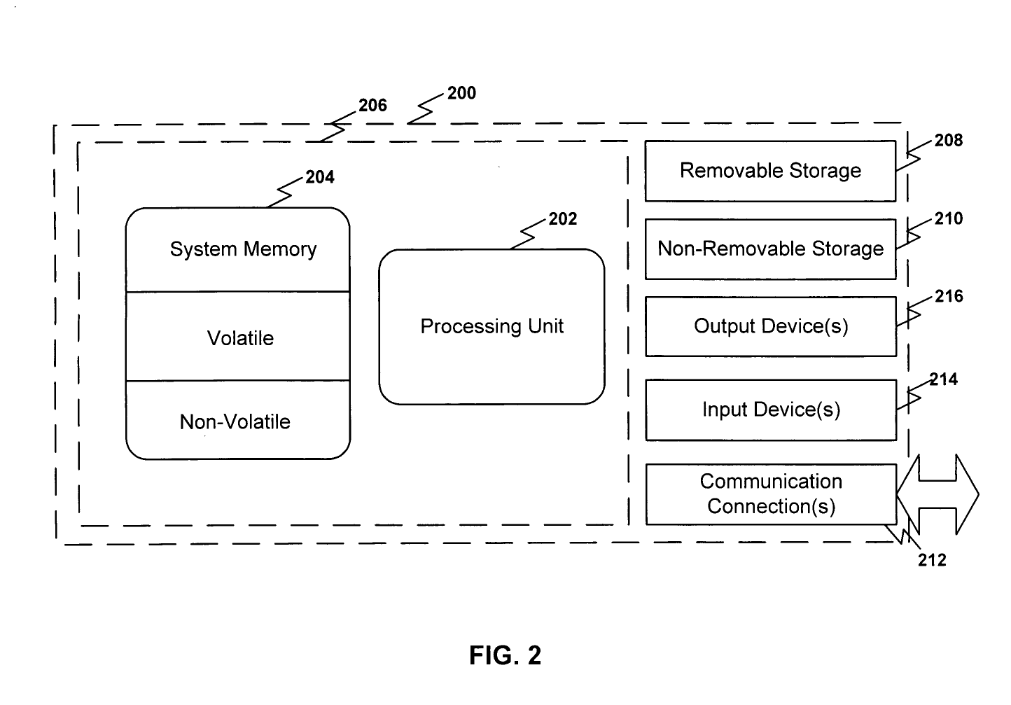

FIG. 2 illustrates an example of a suitable computing system environment on which embodiments of the invention may be implemented. This system 200 is representative of one that may be used to serve as the computer system 105 described above. In its most basic configuration, system 200 typically includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 2 by dashed line 206. Additionally, system 200 may also have additional features/functionality. For example, device 200 may also include additional storage (removable and/or non-removable) including, but not limited to, magnetic or optical disks or tape. Such additional storage is illustrated in FIG. 2 by removable storage 208 and non-removable storage 210. Computer storage media includes volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by system 200. Any such computer storage media may be part of system 200.

System 200 typically includes communications connection(s) 212 that allow the system to communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

System 200 may also have input device(s) 214 such as keyboard, mouse, pen, voice input device, touch input device, etc. Output device(s) 216 such as a display, speakers, printer, etc. may also be included. All these devices are well know in the art and need not be discussed at length here. A computing device, such as system 200, typically includes at least some form of computer-readable media. Computer readable media can be any available media that can be accessed by the system 200. By way of example, and not limitation, computer-readable media might comprise computer storage media and communication media.

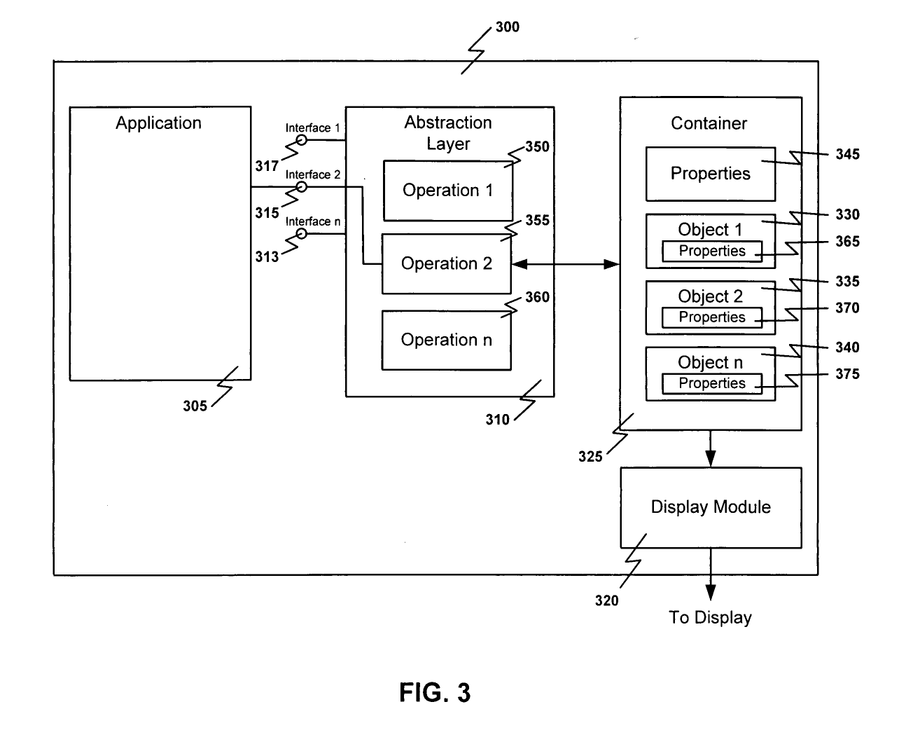

FIG. 3 illustrates functional components of a system for abstraction of logical layout editing operations according to an embodiment of the present invention. As shown here, a computer system 300, such as system 200 or 105 above, may execute one or more applications 305. The application 305 may be any of a variety of possible applications such as a word processor, web browser, email program, or other type of software. The application 305 detects editing operations, including layout editing operations, performed on objects being displayed. For example, a user may select an edge of an object being displayed and drag the edge to resize the object. Once an editing operation such as this arranging operation is detected, the application 305 may request the abstraction layer 310 to perform the appropriate editing operation using an interface 315 provided by the abstraction layer 310. The display module 320 of the computer system 300 displays the objects 330-340 and container 325 based in part on properties 345 or the container 325 as well as properties 365-375 of the objects 330, 335, 340.

The abstraction layer 310 includes a number of interfaces 313, 315, 317 through which the application 305 may initiate a number of corresponding layout editing operations 350, 355, 360. The interfaces 313, 315, 317 and corresponding operations 350, 355, 360 may represent any of a variety of possible editing operations that may be performed by the abstraction layer 310. For example, the abstraction layer 310 may provide for moving, resizing, re-ordering, rotating, skewing, or otherwise manipulating the appearance of the objects within the container 325. Of course, many other possible editing operations may be performed depending upon the exact nature of the container and object and the properties available for those elements. Other editing operations may involve manipulating any property of the object, not necessarily positional properties. For example, sound, text, colors and other properties of the object may be edited by the abstraction layer. Additionally, creating, deleting, copying objects or data can also be done via logical operations through the abstraction layer.

Embodiments of the present invention may be implemented utilizing object-oriented programming techniques. For example, the container 325 and objects 330, 335, 340 may be implemented as instances of a class of a given type. The abstraction layer 310 may also be implemented as an instance of a class. Further, the abstraction layer 310 may inherit the properties 345 of the container 325 as well as the properties 365-375 of each object 330-340. In this way, the abstraction layer 310 may have specific knowledge of the objects 330-340 and the container 325. The abstraction layer class can also provide methods defined for that class representing the logical editing operations 350-360 through the interfaces 313, 315, 317. Therefore, when the application 305 invokes a particular layout editing operation 355 through an interface 315, the corresponding method for that operation 355 may modify properties 345 for the container 325 and/or properties 365-375 for one or more objects 330-340.

The operations of the abstraction layer generally consist of receiving the edit operation and other parameters from the application 305 through an interface 315. For example, an interface for executing a move operation may have a parameter for identifying the object to be moved and a parameter for the amount or distance the object should be moved. The abstraction layer 310 then determines the object to be edited from the parameters and determines the objects container. The abstraction layer 310 then determines the container's type. The abstraction layer 310 may obtain knowledge of the objects 330-340 and the container 325 in a variety of ways. For example, the abstraction layer may read a type attribute for each object and the container. Alternatively, the abstraction layer may read a property setting for each object and the container. In another example, the abstraction layer may read an object type and/or container type from a registry or other persistent memory. Types of containers that may be used may include, but are not limited to, an absolute positioning type, a flowing type, and a docking type. Based on the type of container, the abstraction layer 310 may then perform the appropriate editing operation by modifying the properties of the object being edited and/or the container for that object.

For example, an application, responsive to input from a user or some other event, may request a move operation by calling, invoking, instantiating, or otherwise initiating the move operation of the abstraction layer using the move interface. The application, when initiating the move operation may supply an indication of the distance to be moved or a destination location for the object along with the name or other identification of the object to be moved. The abstraction layer move operation can then identify the object's parent container from the object's properties, determine the parent container's type from the properties of that container or other data, and edit the properties of the container and/or object to affect the move based on how the container arranges it objects. So, if, for example, the container arranges objects therein by an absolute position, the object's x,y coordinates may be edited by the move operation of the abstraction layer. If, in another example, the container arranges objects in a flowing manner, the ordinal value of the object may be edited by the move operation of the abstraction layer.

As mentioned above, the abstraction layer 310 may be implemented as an object oriented class of a predefined type having the methods and properties described. It should be noted that the abstraction layer 310 may represent multiple instances of this class. For example, one instance may be used for each object in a particular container. Additionally, one instance may be used for the container itself. Therefore, the instance for the container and the instances for the objects may, in some cases function independently. There may also be multiple instances for the same object to affect different editing operations. For example, editing operation that affect the container only need not involve the instances for the objects within that container. Different editing operations such as move and rotation could be done by the same or different instances of the abstraction layer. Further, if the abstraction layer is implemented as a class, the class may be made extensible to allow the addition of new operations. For example, various types of three dimensional editing operation may be added.

Various type of containers may be used when displaying objects and child objects. Editing operations performed on child objects within these parent containers may depend on the type of parent container used. Container types that may be used include but are not limited to an absolute positioning type container, a flowing type container, and a docking type container. The following discussion of sizing and arranging of objects in these container types is offered by way of example and not limitation. Various other types of containers and combinations of these and other containers are contemplated.

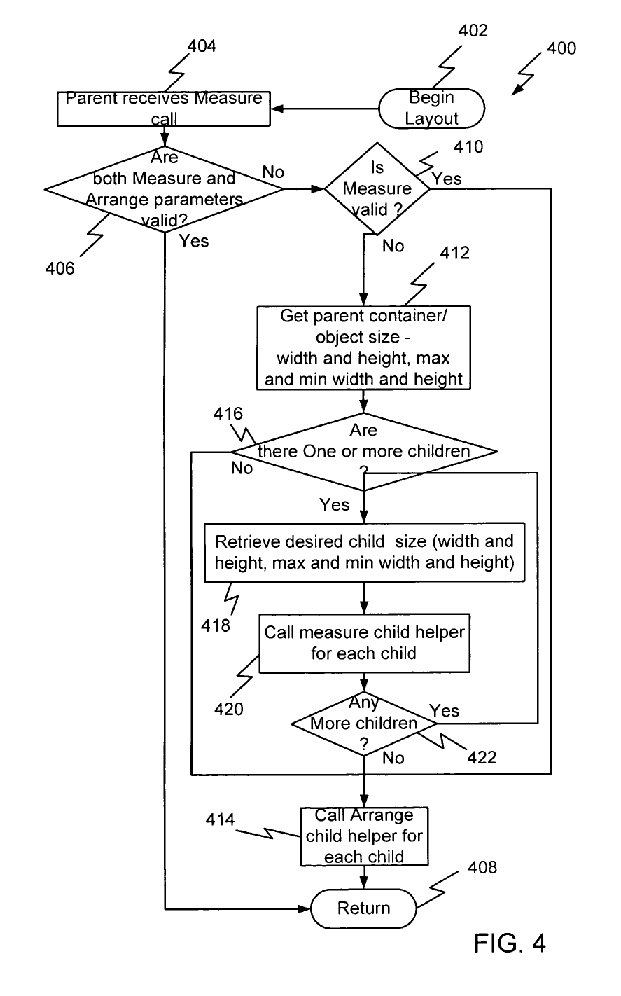

FIG. 4 is a flowchart of the framework layout operations in an embodiment of the present invention, in which a container 115, as shown in FIG. 1, is utilized. This, a well-known example of one type of container, is a desktop such as the Microsoft Windows® desktop. In this type of container 115, three objects 120, 125, and 130 are arranged. Each object has a property indicating the coordinates for at least one of its corners or another anchor. Additionally, each object may also have one or more properties indicating its size. Typically, size may be determined by height and width properties for the object. Size may also have limitations or constraints such as a minimum and/or maximum width, a minimum and/or maximum height, a fixed width and/or height, or a width and/or height that is tied to a function or some other relation to the size of the child object or the parent container. Further, the objects presented in an absolute positioning container, for example, may be positioned anywhere within the container 115.

The operations involved in handling, in a consistent manner, the changing or accommodating of changes in layout of a parent and/or child object is provided in the abstraction or API in an embodiment of the invention. An example of the sequence of operations 400 involved in handling sizing is shown in FIG. 4.

The handling routine 400 begins in operation 402 where a layout call is made from the application 145 to set or modify the layout of an object or container such as object 120 in FIG. 1. Control then transfers to operation 404. In operation 404, the parent object or container receives a Measure Call. The Measure call then retrieves the parent container or object size and any related constraints attributable to the parent container or object. Constraints include such parameters as maximum size, minimum size, minimum width, maximum width, or any functional relationship between the dimensions of the parent container or object. Also included are parameters indicative of whether the object size and position or orientation are already established. These are called Measure parameter and Arrange parameter. Control then transfers to query operation 406.

In query operation 406, the Measure and Arrange parameters retrieved are queried as to whether both parameters are in fact valid. If both of the Measure and Arrange parameters set as valid, control transfers to return operation 408, indicating that no change in the object orientation has been or is being requested. On the other hand, if either one of the Measure and Arrange parameters is set as “invalid”, control transfers to query operation 410.

In operation 410, the query is made whether the Measure parameter is valid. If the answer is yes, the Measure parameter is valid, no re-measuring of the object is required, and control transfers to operation 414. If the answer is no, the Measure parameter is “invalid”, control transfers to query operation 416.

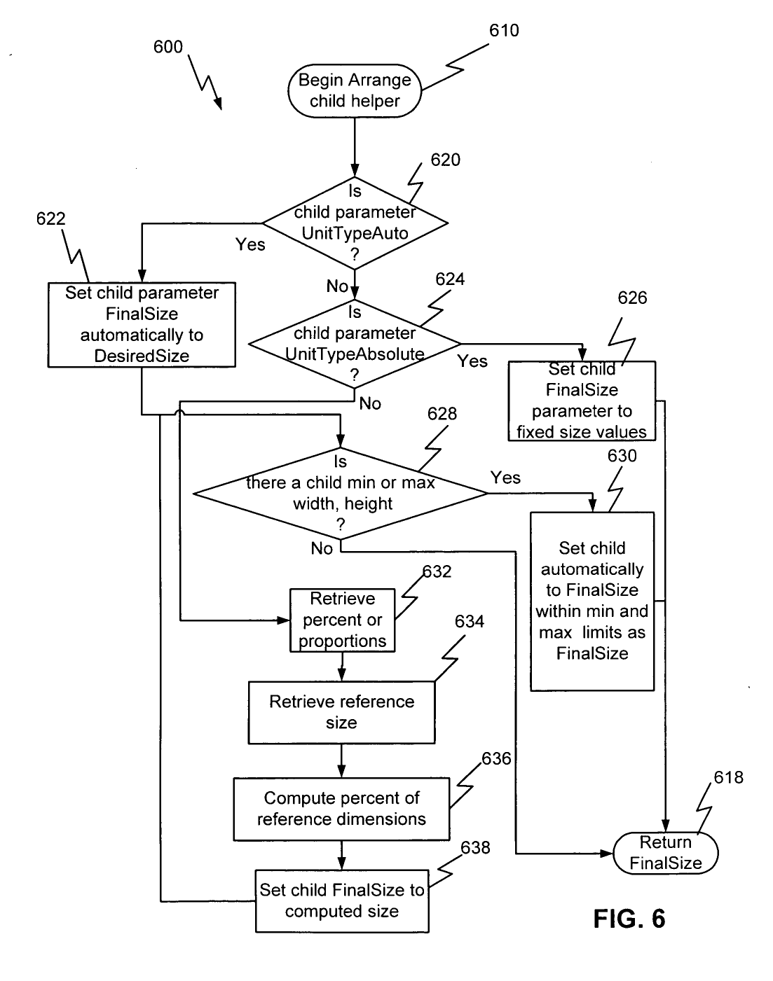

In operation 414, the Arrange Child helper call is made, since the Measure parameter is valid and thus the Arrange parameter must be invalid. The Arrange child helper call establishes the finalSize for each of any child objects present, in accordance with the routine 600 set forth in FIG. 6 and discussed in detail below. On the other hand, if control transferred to query operation 416, the query is made whether the container of interest has one or more children within the parent container or object. If not, control transfers to operation 414. If the answer in query operation 416 is yes, there are children in the parent container or object, control passes to operation 418.

Operation 418 retrieves the next child DesiredSize parameters. In this descriptive case, the first child DesiredSize parameters are retrieved. These parameters are divided into two groups or dimensions, width and height. Within the width dimension are three possible parameters: width, minimum width, and maximum width. Similarly, within the height dimension, there are three possible parameters: height, minimum height, and maximum height. This results in a total of six parameters that may be associated with any given parent or child object. When the child DesiredSize parameters are retrieved, control passes to operation 420.

In operation 420, a call is made to the MeasureChildHelper, described in operational flow 500, discussed below. Upon return from MeasureChildHelper routine 500, control passes to query operation 422 which asks whether there are any more children in the parent container or object. If so, control transfers back to operation 418 and the next child DesiredSize parameters are retrieved, and the call is made in operation 420 for the next child to be subjected to the MeasureChildHelper routine 500. When there are no more children identified in query operation 422, control transfers to operation 414.

In operation 414, the call is made to the ArrangeChildHelper routine 600 shown in FIG. 6. When control returns to operation 414 after the ArrangeChildHelper is completed for all children in the parent container, control returns to the calling layout API as the sizing operation within the parent container or object is now complete.

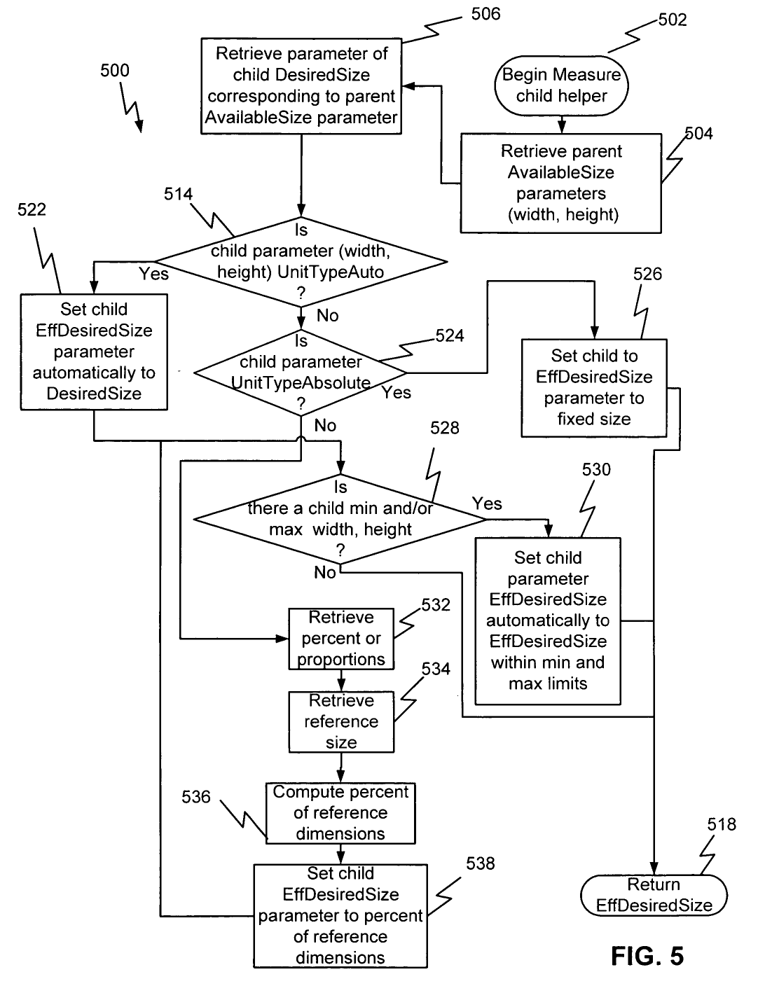

FIG. 5 is a flowchart of the measure child helper 500 operations in accordance with an exemplary embodiment of the present invention. When the framework layout routine 400 calls the measure child helper routine 500 in operation 418, control transfers to start measure child helper operation 502. Control then transfers to operation 504. In operation 504, the AvailableSize parameters for the child object's parent container or object are retrieved. These parameters may be up to six and again can be viewed as within two dimensional groups, width and height. The parameters in this embodiment are width, max width, min width, and height, max height, and min height. Control then transfers to operation 506.

In operation 506, the child parameters of DesiredSize for the particular child called in operation 418 above are compared to the corresponding AvailableSize parameters of the parent container or object. In this operation 506, if the DesiredSize parameter is greater than the parent AvailableSize parameter, the child EffDesiredSize might be set to the parent AvailableSize value and returned to operation 420. In other embodiments, the designer may specify to the parent that the parent size could be adjusted in accordance with other constraints such as letting the child size dominate. However, for this illustrative embodiment, the parent parameters are assumed to control. In this case, if the child DesiredSize parameters are less than the AvailableSize values, each of the parameters is compared and for each of the two dimensions: width and height, the processes described below in operations 514 through 538 are performed, preferably in parallel.

When control transfers from operation 506 to operation 514, the query is made whether the particular child parameter, width or height is “UnitTypeAuto”. If the answer is yes, the child parameter is UnitTypeAuto, this means that no size constraint has been attributed to the child object. Control transfers to operation 522. In operation 522, the child EffDesiredSize parameter is set to the DesiredSize value such that spacing of other children within the container are automatically arranged within the parent container. In this case, the width, height, margins and padding are automatically sized to accommodate the DesiredSize content of the child. Control then transfers to query operation 528.

In query operation 528, the query is made whether there is a minimum or maximum constraint on the child parameter. If yes, then control transfers to operation 530, in which the child EffDesiredSize is automatically set to the child's DesiredSize value within the minimum or maximum limitations of the constraints on the child. Control then transfers to return EffDesiredSize operation 518. If the answer to query operation 528 is no, there is no minimum or maximum width or minimum or maximum height constraint specified on the child parameter, then control transfers directly to return EffDesiredSize operation 518.

If the answer to query operation 514 is no, the child parameter is not “UnitTypeAuto”, control transfers to query operation 524. In query operation 524, a query is made whether the child parameter is “UnitTypeAbsolute”. If so, the width or height parameter being examined is a fixed value and is not to be changed. In this case, control then transfers to operation 526.

In operation 526, the child EffDesiredSize is set to the fixed value associated with that child. For example, the width of the child object may be fixed at 400 pixels. Accordingly, the width remains constant and only the height may vary to accommodate the content of the child. Alternatively, the height may be constant, with the width varying to accommodate the content of the child. Control then transfers to return EffDesiredSize operation 518 where control returns to calling operation 420.

If the answer to query operation 524 is no, the child parameter is not UnitTypeAbsolute, i.e. is not fixed, control transfers to operation 532. In operation 532, a percent, proportion or other functional relationship requirement imposed on the width and/or height is retrieved. Control then transfers to operation 534. In operation 534, a ReferenceSize value is retrieved for the child object parameter. Control then transfers to operation 536.

In operation 536, the functional relationship identified in operation 532 is applied to the ReferenceSize for the child parameter (width or height). For example, the functional relationship may be that the width and height of the child is to be maintained at 50% of the parent width. Or, the height of the child is to be maintained constant and the width is to be maintained at ⅕ of the parent width, or some other relation. In operation 536, the computation is performed to determine the values of the width, height, overall size etc as dictated by the relationship identified in operation 532. Control then transfers to operation 538.

In operation 538, the child EffDesiredSize is set to the value for the child parameter calculated in operation 536, for example, to the percent of the reference dimensions dictated. Control then passes to query operation 528. In query operation 528, the query is made whether there is a minimum or maximum constraint on the child parameter. If yes, then control transfers to operation 530, in which the child EffDesiredSize is automatically set to the child's DesiredSize value within the minimum or maximum limitations of the constraints on the child. Control then transfers to return EffDesiredSize operation 518. If the answer to query operation 528 is no, there is no minimum or maximum width or minimum or maximum height constraint specified on the child parameter, then control transfers directly to return EffDesiredSize operation 518.

Once the measure child helper routine 500 has been performed for each child object, i.e., the answer in query operation 422 in FIG. 4 is no, control passes to operation 414 as shown in FIG. 4 which calls the Arrange child helper routine 600 shown in FIG. 6. This routine 600 also resides in the abstraction or application program interface 150 and proceeds similarly to the measure child routine 500 shown in FIG. 5.

When the framework layout sequence of operations 400 calls the Arrange child helper routine 600 in operation 414, control transfers to begin Arrange child helper operation 610, in which the first child EffDesiredSize parameter associated with the child object that is being considered is retrieved. Control then transfers from operation 610 to query operation 620 where the query is made whether the child Arrange parameter is set to “UnitTypeAuto”. If the answer to query operation 620 is yes, control transfers to operation 622. If the answer to query operation 620 is no, control transfers to query operation 624.

In operation 622, the child Arrange parameter is “UnitTypeAuto”, the child FinalSize parameter is automatically adjusted to the child EffDesiredSize value. Control then transfers to a query operation 628. In query operation 628, the query is made whether there is a minimum or maximum positional constraint on the child dimension. If yes, then control transfers to operation 630, in which the child dimension is automatically set to its EffDesiredSize within the minimum or maximum limitations of the constraints on the child. Control then transfers to Return FinalSize operation 618.

If the answer to query operation 628 is no, there is no minimum or maximum arrangement constraint on the child dimension (width or height), then control transfers directly to return FinalSize operation 618. Control then returns to operation 414 which then calls routine 600 for the next child, if any.

On the other hand, if, in operation 620, the answer is no, the child Arrange parameter is not UnitTypeAuto, and control transferred to query operation 624, the query is made in operation 624 whether the child arrangement is UnitTypeAbsolute. This query determines if there is a fixed dimensional parameter, (e.g. either width or height) for the child. If any of these parameters are a set fixed value, the answer is yes, and control transfers to operation 626. In operation 626, the child FinalSize is set to the fixed width or height parameter value associated with that child. Control then transfers to return FinalSize operation 618.

If the answer to query operation 624 is no, the child arrangement is not fixed, then control transfers to operation 632. In operation 632, a percent, proportion or other functional relationship requirement of the arrangement is retrieved. Control then transfers to operation 634. In operation 634, a ReferenceSize parameter is retrieved for the child object. Control then transfers to operation 636.

In operation 636, the functional relationship identified in operation 632 is applied to the ReferenceSize for the child dimension. For example, the functional relationship may be that the distance from the borders of the parent is to be maintained at 50% of the parent width. Or, the center of the child is to be maintained ⅕ of the parent width from the parent center, or some other relation. In operation 636, the computation is performed to determine the value as dictated by the parameters identified in operation 632. Control then transfers to operation 638. In operation 638, the child FinalSize is set to the parameters calculated in operation 636, for example, to the percent of the reference dimensions dictated. Control then passes to query operation 628.

In query operation 628, the query is made whether there is a minimum or maximum positional constraint on the child dimension. If yes, then control transfers to operation 630, in which the child dimension is automatically set to its EffDesiredSize within the minimum or maximum limitations of the constraints on the child. Control then transfers to Return FinalSize operation 618. If the answer to query operation 628 is no, there is no minimum or maximum arrangement constraint on the child dimension (width or height), then control transfers directly to Return FinalSize operation 618. Again, control returns to operation 414 in FIG. 4 which returns to routine 600 if there are any more children in the container 115.

Other layout parameters may also be handled in a consistent manner such as is described above with reference to child physical size and child arrangements. These include margin relationships and padding between and around objects and containers to be displayed or otherwise rendered to an output device.

The measure child helper and arrange child helper routines or calls described above are particularly suited to enhance operation of the core Measure call and core Arrange call described in detail in the related applications first set forth above. Further, as described above, child object and/or the container layout may be edited by modifying the various other properties of the child object or even the parent object or container. For example, a child object may be moved by modifying the absolute position properties or the ordinal value properties depending upon the type of parent container. In another example, a child object may be resized by modifying a height and/or width property in accordance with limitation parameters provided in the child or parent or both. Of course, many other possible editing operations may be performed depending upon the exact nature of the container and object and the properties available for those elements. Other editing operations may involve manipulating any property of the object, not necessarily positional or special size properties. For example, sound, text, colors and other properties of the object may be edited by utilizing the API abstraction layer in a similar manner. In addition the above description involved an exemplary two-dimensional layout representation involving object width and height parameters. The above may also be applied to a multidimensional graphical User interface API such as a three dimensional representation.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of editing layout of a child object associated with a parent object or container displayed on a video display by a computer system, the method comprising:
detecting a layout edit operation for the child object displayed on the video display by the computer system; and
determining from the child object and the parent whether there exists one or more parameters associated with one of the child and the parent; and
editing the layout of the child object if a parameter limitation exists for the parameter, in accordance with the one or more parameter limitations.

2. The method of claim 1, wherein the detecting operation is performed via an abstraction layer.

3. The method of claim 2, wherein the determining operation comprises:
determining a container type for the parent object or container in which the child object is displayed;
retrieving a set of properties related to the child object to be edited;
retrieving a set of properties related to the parent container in which the object is displayed and
recognizing any limitations that exist within the sets of properties.

4. The method of claim 3, wherein the operation of editing comprises:
determining whether the one or more child limitations includes a maximum dimension; and
limiting adjustment of the dimension of the child to less than or equal to the maximum if the maximum dimension is present.

5. The method of claim 3, wherein the editing operation comprises.
determining whether the one or more child limitations includes a functional relationship between the child and parent; and
retrieving a ReferenceSize if a functional relationship exists; and
calculating new layout parameters for the child based on the functional relationship.

6. The method of claim 3, wherein editing the child object comprises modifying one or more properties of the child object.

7. The method of claim 3, wherein editing the child object comprises modifying one or more properties of the parent object or container.

8. A system for editing a layout of a child object displayed within a parent container on a video display comprising:
a processor; and
a memory coupled with and readable by the processor and containing instructions that, when executed by the processor, cause the processor to detect a layout edit operation request for a child object displayed on the video display by the computer system, send an edit operation request via an application program interface to initiate layout editing of the child object, determine whether the child object has one or more parameter limitations, determine whether the parent container has one or more parameter limitations, and edit the child object layout based on the limitations and the received edit operation request.

9. The system of claim 8 further comprising the processor containing instructions, that, when executed by the processor, cause the processor to perform a child object measure helper operation and a child object arrangement helper operation on the child when a layout edit operation request is detected.

10. The system of claim 8, wherein one or more of the child limitations includes a functional relationship of size between the child and the parent.

11. The system of claim 10, wherein the functional relationship is a proportional relationship between the child and the parent.

12. The system of claim 11, wherein editing the layout of the child object comprises maintaining the proportional relationship between the child and the parent.

13. The system of claim 8, wherein editing the child object comprises modifying one or more layout properties of the parent container.

14. A machine-readable medium encoding a computer program of instructions for editing objects displayed on a video display by a computer system, said computer process comprising:
detecting a layout edit operation for a child object displayed on the video display by the computer system; and
determining from the child object and a parent container displayed on the display whether there exists one or more layout parameter limitations associated with one of the child and the parent; and
editing the layout of the child object if a limitation exists, in accordance with the one or more layout parameter limitations.

15. The machine-readable medium of claim 14, wherein the determining further comprises:
determining a container type for the parent object or container in which the child object is displayed;
retrieving a set of layout parameters related to the child object to be edited;
retrieving a set of layout parameters related to the container in which the object is displayed and
recognizing any layout limitations that exist within the sets of layout parameters.

16. The machine-readable medium of claim 14, wherein the editing of the layout of the child object comprises:
determining whether the one or more child layout limitations includes a functional relationship between the child and parent; and
retrieving a ReferenceSize if a functional relationship exists; and
calculating new layout parameters for the child based on the functional relationship and the ReferenceSize.

17. The machine-readable medium of claim 14, wherein the detecting operation is performed via an abstraction layer.

18. The machine-readable medium of claim 17, wherein editing the child object further comprises determining whether a layout limitation of the child is a proportional relationship to the parent container and if so, maintaining the proportional relationship between the layout of the child object and the parent container.

19. The machine-readable medium of claim 17, wherein editing the object comprises modifying one or more properties of the child object in a child measure helper routine in the abstraction layer.

20. The machine-readable medium of claim 19 further comprising modifying one or more properties of the child object in a child arrangement routine in the abstraction layer consistent with one or more limitations in the parent container.
